(19) United States
(12) Patent Application Publication
(10) Pub. No.: US 2011/0106501 A1
(43) Pub. Date: May 5, 2011

(54) AUTOMATED DESIGN OF AN IT INFRASTRUCTURE

(76) Inventors: Thomas W. Christian, Fort Collins, CO (US); Yuan Chen, Sunnyvale, CA (US); Chih C. Shih, San Jose, CA (US); Ratnesh Kumar Sharma, Fremont, CA (US); Christopher Edward Hoover, Campbell, CA (US); Manish Marwah, Mountain View, CA (US); Amip J. Shah, Santa Clara, CA (US); Chandrakant Patel, Fremont, CA (US); Cullen E. Bash, Los Gatos, CA (US); Daniel Juergen Gmach, Palo Alto, CA (US)

(21) Appl. No.: 12/608,524

(22) Filed: Oct. 29, 2009

(51) Int. Cl. G06F 17/50

(52) U.S. Cl. 703/1

(57) ABSTRACT

A method for automated design of an IT infrastructure, includes a) identifying IT equipment to support services to be provided to meet one or more user requirements; b) identifying one or more auxiliary infrastructures to meet requirements of the identified computer equipment; c) synthesizing the IT equipment and the one or more auxiliary infrastructures to generate a candidate design; d) analyzing one or more operating characteristics of the candidate design; e) repeating steps a)-d) on at least one additional candidate design that differs from the candidate design generated at step c); and f) storing at least one of the candidate design and the at least one additional candidate design.

### CROSS REFERENCE TO RELATED APPLICATIONS

The present application contains similar subject matter and refers to U.S. Provisional Application Ser. No. 60/989,335, filed on Nov. 20, 2007, and entitled “Data Center Synthesis”, and U.S. patent application Ser. No. TBD (Attorney Docket No. 200702605-1), which claims priority to the 60/989,335 Provisional Application, filed on TBD, the disclosures of which are hereby incorporated by reference in their entireties.

### BACKGROUND

Information Technology (IT) infrastructures are typically designed using static information about equipment and operating conditions. In addition, to ensure adequate capacity in the IT infrastructures, power and cooling requirements are calculated assuming all of equipment in the IT infrastructures are in operation and under nominal load. As such, conventional IT infrastructure designs typically do not consider the possibility of real-time load management to optimize resource utilization, which often leads to over-provisioning of the computing, power, and cooling requirements. IT infrastructure availability is also typically not considered in the design process. However, when IT infrastructure availability is considered, provisions for the IT infrastructure availability are typically made based upon the designer's judgment, which often leads to over-provisioning for sufficient availability.

Conventional IT infrastructure design approaches therefore result in IT infrastructure designs that are over-provisioned for the services that the IT infrastructures are intended to provide. One result of this over-provisioning is that the conventionally designed IT infrastructure are associated with unnecessarily high total costs of ownership. Moreover, conventional IT infrastructure design approaches fail to consider environmental factors, and thus, the conventionally designed IT infrastructures are often more harmful to the environment than is necessary.

### BRIEF DESCRIPTION OF DRAWINGS

The embodiments of the invention will be described in detail in the following description with reference to the following figures.

FIG. 1 illustrates a simplified block diagram of an automated designing system, according to an embodiment of the invention;

FIG. 2 illustrates a method of automatically designing an IT infrastructure to meet a user's objectives while optimizing one or more of operating characteristic metrics of the IT infrastructure, according to an embodiment of the invention;

FIG. 3 illustrates a process flow diagram of a manner in which the IT equipment used in the IT infrastructure may be selected, according to an embodiment of the invention; and

FIG. 4 illustrates a computing apparatus configured to implement or execute the methods depicted in FIGS. 2 and 3, according to an embodiment of the invention.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Disclosed herein is a method and a synthesizer for automatically designing an information technology (IT) infrastructure, which may include a data center, container, module, distributed cloud computing infrastructure, or other location or locations where computing processes are performed. The method and synthesizer disclosed herein are configured to automatically design the IT equipment as well as auxiliary infrastructures, such as, power and cooling equipment, employed in the IT infrastructure with a focus on meeting a user's objectives. The user's objectives may be based upon performance level requirements, availability requirements, anticipated workload profiles, anticipated workload compound annual growth rate, anticipated design lifetime, etc. The method and synthesizer disclosed herein are also configured to automatically design the IT infrastructure to substantially minimize one or more operating characteristics, such as, total cost of ownership, carbon emissions, heat load generation, exergy consumption or destruction, etc.

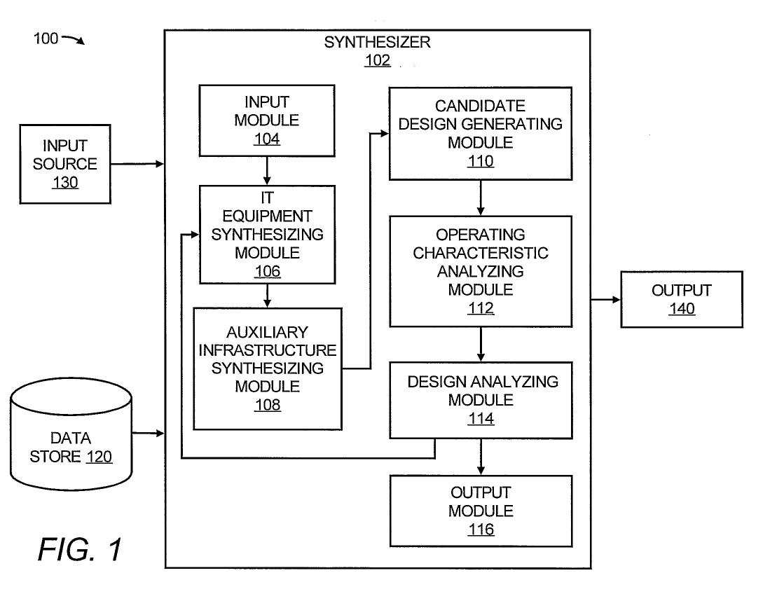

With reference first to FIG. 1, there is shown a simplified block diagram of an automated designing system 100, according to an example. It should be understood that the designing system 100 may include additional elements and that some of the elements described herein may be removed and/or modified without departing from a scope of the designing system 100.

The system 100 is depicted as including a synthesizer 102, an input source 130, and an output 140. The synthesizer 102 is also depicted as including an input module 104, a IT equipment synthesizing module 106, an auxiliary infrastructure synthesizing module 108, a candidate design generating module 110, an operating characteristic analyzing module 112, a design analyzing module 114, an output module 116, and a data store 120. Various manners in which the modules 104-116 operate are discussed in detail herein below.

According to an example, the synthesizer 102 comprises software stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 104-116 comprise software modules stored in the memory, which are executable by a processor of a computing device. According to another example, the synthesizer 102 comprises a hardware device, such as, a circuit or multiple circuits arranged on a board. In this example, the modules 104-116 comprise circuit components or individual circuits, which may also be controlled by a processor of a computing device. According to a further example, the synthesizer 102 comprises a combination of hardware and software modules. In addition, multiple processors may be employed to implement or execute the synthesizer 102.

Generally speaking, the synthesizer 102 is configured to automatically identify one or more IT infrastructure designs that integrate computing, power, and cooling requirements to meet service level objectives while optimizing one or more operating characteristic metrics. The service level objectives may be defined by a user of the IT infrastructure based upon one or more objectives that the user seeks to obtain from operation of the IT infrastructure, for instance, a description of the services to be provided, the required level of performance, the required level of availability, workload activity profile, anticipated compound annual growth rate (CAGR), the design lifetime of the IT infrastructure, etc.

In addition, the operating characteristics metrics may include, for instance, the total cost of ownership (TCO), the availability, the thermal performance, the water consumption, the exergy consumption, etc. The TCO may include the acquisition costs as well as the operational costs associated with the IT infrastructure. The availability of the IT infrastructure may be calculated from an aggregation of the reliability figures of the components contained in the IT infrastructure. In addition, the exergy consumption may be defined as the operational exergy loss, the total embedded exergy consumed by the components contained in the IT infrastructure, the sum of these items, etc.

A user may employ an input source 130 to input the service level objectives and/or other information into the synthesizer 102. The input source 130 may comprise an interface device, such as, a keyboard, mouse, or other input device, to input the objectives into the synthesizer 102, or the input may be provided programmatically through a software interface from another application. In one particular example, the user may be provided with a number options with respect to the objectives, which the user may select through the input source 130.

In any regard, the objectives may be stored in the data store 120, which may comprise any reasonably suitable memory upon which the synthesizer 102 may store data and from which the synthesizer 102 may retrieve data. Although the data store 120 has been depicted as forming a separate component from the synthesizer 102, it should be understood that the data store 120 may be integrated with the synthesizer 102 without departing from a scope of the system 100.

The synthesizer 102 may also output one or more of the synthesized designs as well as other information through the output module 116 to the output 140. The output 140 may comprise, for instance, a display upon which the outputted information may be displayed, a printer upon which the outputted information may be printed, a connection over which the outputted information may be conveyed to another computing device, a data storage device upon which the outputted information may be stored, etc.

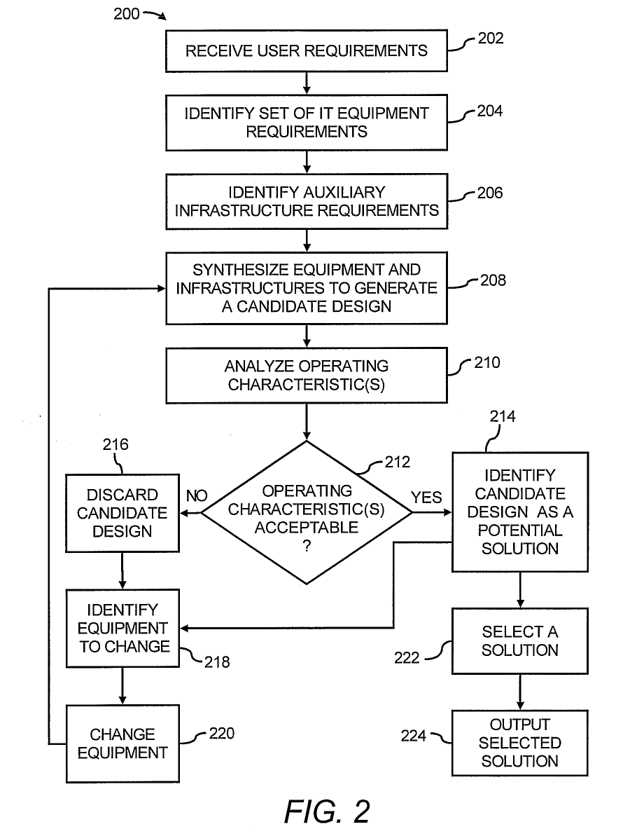

Various manners in which the modules 104-116 of the synthesizer 102 may operate in designing an IT infrastructure is discussed with respect to the method 200 depicted in FIG. 2. FIG. 2, more particularly depicts a method 200 of automatically designing an IT infrastructure to meet the user's objectives while optimizing one or more of the operating characteristic metrics, according to an example. It should be apparent to those of ordinary skill in the art that the method discussed below with respect to FIG. 2 represents a generalized illustration and that other steps may be added or existing steps may be removed, modified or rearranged without departing from a scope of the method 200.

Although particular reference is made to the system 100 depicted in FIG. 1 as performing the steps outlined in the method 200, it should be understood that the method 200 may be performed by a differently configured system 100 without departing from a scope of the method 200. In addition, the method 200 may be implemented by a user of the synthesizer 102 or the method 200 may be implemented to automatically design an IT infrastructure for a client of the synthesizer 102 user.

At step 202, the synthesizer 102 receives one or more requirements of the IT infrastructure user. The requirements may include the service level objectives discussed above, which may include one or more user-identified objectives. Thus, for instance, the requirements may include descriptions of the services to be provided, the level of performance required, the level of availability required, the activity profile of the workload to be performed, the anticipated compound annual growth rate, the anticipated design lifetime of the IT infrastructure, etc.

At step 204, a set of generic IT equipment requirements to support services to be provided to meet the one or more user requirements is identified, for instance, by the IT equipment synthesizing module 106. In other words, at step 204, the IT equipment, including the computing, storage, and networking equipment to be employed in the IT infrastructure, are sized to identify the IT equipment requirements needed to support the user-specified services to be performed in the IT infrastructure, while meeting the other requirements. For instance, the IT equipment synthesizing module 106 may employ dynamic services templates that provide information about the computing, networking and storage requirements to support the specified services. At this point, the requirements are specified by generic IT equipment requirements and may not be associated with any particular brand, model or configuration of IT equipment.

In addition, at step 204, the IT equipment requirements are translated into specific equipment models and specifications, for instance, by the IT equipment synthesizing module 106. More particularly, the set of computer equipment requirements may be compared with available makes and models of a number of candidate IT equipment and a set of IT equipment that meets the identified requirements may initially be selected from the candidate IT equipment. In addition, IT equipment requirements for IT equipment configured to operate as adjuncts to the IT equipment identified to perform the specified services may also be identified at step 204.

According to an example, equipment templates that contain complete specifications for the IT equipment are relied upon in translating the IT equipment requirements into the specific equipment models and specifications. In addition, in instances where the IT equipment are intended to be employed in a virtualized environment, a mapping of the virtualized IT equipment to the specific equipment models and specifications is performed at step 204. The specifications may include, vendor, model, relative performance, acquisition cost, power consumption, heat generation, embedded exergy, embedded carbon emissions, etc. Thus, for instance, the equipment templates may be used to map the generic IT equipment requirements to the specific equipment models, vendors, etc. The equipment templates may also include information pertaining to the sustainability attributes of the IT equipment, such as, embedded exergy consumption, carbon emissions, etc.

One or more of the specifications may be weighed differently with respect to each other in determining which of the candidate IT equipment to select at step 204. Thus, for instance, the IT equipment synthesizing module 106 may be programmed to make the performance or price of the IT equipment have the highest weight. However, in another example, the IT equipment synthesizing module 106 may instead be programmed to accept IT equipment that fail to meet the requirements determined at step 204 if, for instance, the IT equipment has other desirable attributes, such as, low acquisition cost or low sustainability impact. By way of particular example, the IT equipment synthesizing module 106 may determine that a particular solution exceeds a target capital equipment budget by 5%, but in return lowers operating costs and carbon emissions by 20%. In this particular example, the IT equipment synthesizing module 106 may select the particular solution even though the budget has been exceeded because of the benefits in terms of operating costs and environmental sustainability. In one regard, therefore, users may be provided with multiple alternatives and may be able to make sensible trade-offs as part of the final decision process in designing the IT infrastructure. In any event, IT equipment that are able to accommodate planned workload growth without major disruption of the IT infrastructure may be selected.

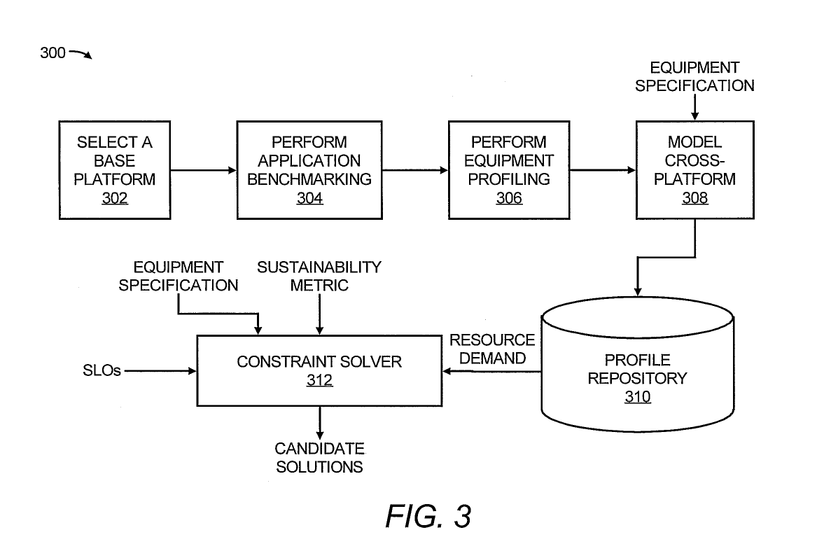

With particular reference now to FIG. 3, there is shown a process flow diagram 300 of a manner in which the IT equipment may be selected to support the services to be provided, while meeting the one or more other user requirements, according to an example. In addition, the IT equipment synthesizing module 106 may perform the process flow depicted in FIG. 3.

As shown therein, at step 302, a base platform, including IT equipment is selected. In addition, at step 304, an application benchmarking operation on the base platform selected at step 302 is performed to identify various characteristics of the application on the selected base platform. The benchmarking operation may include, for instance, a determination of how well the application runs on the selected base platform and how the IT equipment in the selected base platform responds to anticipated workloads. The output includes the resource utilization, performance, etc., of the selected base platform

At step 306, a profiling operation is performed to identify the resource demand of the application on the selected base platform. The resource demand may be obtained through performance of a statistical regression analysis on the data collected at step 304.

At step 308, given any candidate IT equipment with its specification (e.g., CPU clock speed, memory size), a cross-platform modeling operation is performed to predict the performance and resource demand of the application on the candidate IT equipment. The cross-platform modeling may use known performance and resource demand information on the base platform generated at step 306 and the specification of the candidate IT equipment to identify the resource demand of the application associated with the IT equipment. In addition, the IT equipment synthesizing module 106 may store the identified resource profile in the profile repository 310.

The IT equipment synthesizing module 106 may repeat step 308 for a number of different IT equipment to populate the profile repository 310 with resource profiles for a number of different platforms.

The constraint solver 312 is configured to receive various inputs and to generate one or more candidate solutions that satisfy one or more constraints associated with selecting the IT equipment to be used in the IT infrastructure. More particularly, the constraint solver 312 is depicted as receiving service level objectives (SLOs), specifications of the IT equipment that may be selected for the IT infrastructure, sustainability metrics of the IT equipment, and resource demands of the IT equipment from the profile repository 310. The constraint solver 312 is generally configured to identify one or more sets of IT equipment that meet the requirements set forth in the SLOs, which may be based upon performance, TCO, sustainability, etc. In addition, the constraint solver 312 is configured to output the identified one or more sets of IT equipment as candidate solutions for the IT equipment to be employed in the IT infrastructure. As such, the constraint solver 312 is configured to output a list of computing equipment, such as computing, networking, and storage devices, that are able to provide the specified services while meeting the SLOs and other user-defined constraints.

According to an example, the constraint solver 312 may consider additional constraints in identifying the one or more sets of IT equipment. The additional constraints may include, for instance, one or more user constraints pertaining to, for instance, particular vendors and/or model numbers for the IT equipment. Thus, for instance, a user may constrain the IT infrastructure design to use particular IT equipment.

The constraint solver 312 may also consider additional factors in selecting the one or more sets of IT equipment. According to an example, the constraint solver 312 may analyze the workload profile, for instance, activity as a function of time of day, and equipment performance characteristics and may select a set of IT equipment that minimizes costs and environmental impact while meeting quality of service requirements. In addition, the constraint solver 312 may factor the anticipated annual growth of the services into the analysis, for instance, to make provisions for cost effective IT infrastructure expansion.

With reference back to FIG. 2, the result of step 204 is a list of computing, networking, and storage equipment, as well as other equipment, that have been determined as being able to provide the specified services while meeting the required quality of service.

At step 206, the auxiliary infrastructure equipment requirements needed to meet the operating characteristics of the IT equipment identified at step 204 are identified, for instance, by the auxiliary infrastructure synthesizing module 108. The auxiliary infrastructure equipment may include, for instance, power and cooling equipment, as well as other equipment or infrastructures, such as, cooling provisioning arrangements, etc. More particularly, for instance, the total heat output expected to be generated by the identified IT equipment and the total power expected to be required by the identified IT equipment and the identified cooling equipment are determined at step 206. The total heat output expected to be generated by power equipment employed to supply power to the computer equipment and the cooling equipment may also be determined. From this information the auxiliary infrastructure, for instance, including the total power and cooling required for the IT infrastructure, is determined.

In addition, at step 206, the auxiliary infrastructure requirements are translated into specific equipment models and specifications that are capable of meeting the auxiliary infrastructure requirements. More particularly, for instance, the auxiliary infrastructure equipment synthesizing module 108 may compare the identified power requirements with available makes and models of power equipment, such as, power supplies, cables, converters, batteries, etc., and may select power equipment that meets the identified requirements. In addition, the auxiliary infrastructure synthesizing module 108 may compare the cooling requirements with available makes and models of cooling equipment, such as, air conditioning units, chillers, blowers, etc., and may select cooling equipment that meets the identified requirements.

The auxiliary infrastructure synthesizing module 108 may also identify cooling equipment requirements for auxiliary infrastructures configured to operate as adjuncts to the identified auxiliary infrastructures. The adjunct auxiliary infrastructures may include, for instance, ventilation tiles, temperature sensors, variable airflow valves, couplings, brackets, etc.

Equipment templates, which may contain complete specifications for particular pieces of auxiliary infrastructures may be employed in translating the identified auxiliary infrastructures into specific equipment models and specifications. The specifications may include, vendor, model, relative performance, acquisition cost, power consumption, heat generation, embedded exergy consumption, embedded carbon emissions, etc., for the particular pieces of auxiliary infrastructures.

According to a particular embodiment, the expected inlet and outlet air temperatures for one or more racks configured to hold some of the IT equipment and any planned ambient operating temperature in the IT infrastructure are employed as guides in selecting the auxiliary infrastructures. In addition, workload and growth profiles from the services specifications combined with knowledge of real-time performance management capabilities for software service instances and IT infrastructure hardware may be used to specify a minimal solution that meets the cooling and power requirements, while allowing for economical future expansion.

In addition, or alternatively, knowledge of local geography, infrastructure and regulations may be used in selecting the auxiliary infrastructures. For example, the local environment, such as, climate and wind characteristics, of the zone in which the IT infrastructure is to be located may be used as a guide in selecting the cooling equipment. By way of particular example, a lack of reliable power may require local power generation facilities and climate or water availability may constrain the types of cooling solutions suitable for the intended IT infrastructure site. As another example, a plurality of a different locations may be considered for the IT infrastructure placement and the location having the most favorable conditions may be selected for placement of the IT infrastructure.

Additional considerations pertaining to one or more of: IT infrastructure power and cooling demand profiles with desired availability levels; utility electricity and natural gas tariffs; capital, operating and maintenance, and fuel costs of various alternatives; available energy sources; available distributed energy conversion technologies, such as fuel cells, photovoltaic, etc.; rate of carbon emissions from the macro-grid and from on-site power generation of power and heat; carbon tax rates or allowable emissions; thermodynamic parameters governing the use of combined heat and power technologies and energy storage; and waste heat utilization strategy, for instance, use of waste heat for desalination, building heating, digesters, etc., may also be employed in selecting the auxiliary infrastructures. According to an example, the auxiliary infrastructures are selected to minimize the total cost of ownership by maximizing the utilization of available energy to deliver power and remove heat at the desired availability and emissions levels.

The output of step 206 is a specific list of auxiliary infrastructures that are capable of meeting the power and cooling requirements of the identified IT equipment. More particularly, the specific list may contain auxiliary infrastructures that are both capable of meeting the power and cooling requirements and also the one or more requirements received at step 202. In addition, one or more of: choice of technologies and installed capacities; operating schedules and policies for control and management; total cost of ownership; total carbon emissions; and coefficient of performance (COP) of the ensemble, which is the ratio of the change in heat to the supplied power, may also be output at step 206.

At step 208, the IT equipment and the auxiliary infrastructures are synthesized to generate a candidate design, for instance, by the candidate design generating module 110. More particularly, a complete model and physical layout of the IT infrastructure is generated at step 208, which incorporates all of the computing, networking, storage devices, and auxiliary infrastructures, including the power equipment and cooling infrastructure, required to meet the one or more requirements identified at step 202. According to a particular example, the candidate design generating module 110 generates a complete model and physical layout through implementation of design best practices. According to another particular example, particular guidelines based upon expert knowledge, such as, placing air conditioning units around a perimeter of a room, separating the inlets and outlets of the computer equipment into cold aisles and hot aisles in the room, etc., may be used in generating the model and physical layouts.

In one regard, the candidate design generating module 110 may be connected to an existing automated modeling tool, which may be implemented in generating the model and physical layouts of the IT infrastructure. More particularly, the model and physical layout of the IT infrastructure may be generated as a complete three-dimensional physical layout of the IT infrastructure suitable for input into a computational fluid dynamics (CFD) application for thermal analysis. According to an example, multiple models and physical layouts of the IT infrastructure using the equipment identified at steps 204 and 206 may be synthesized at step 208. In this example, the identified equipment may be arranged in various configurations to meet, for instance, the availability requirements set forth at step 202.

At step 210, one or more operating characteristics of the candidate design generated at step 208 are analyzed, for instance, by the operating characteristic analyzing module 112 or replaying historical workload demand traces and determining operating characteristics through simulation. The operating characteristics may include, for instance, sustainability criteria, performance, availability, thermal characteristics, TCO, etc. The sustainability criteria includes power consumption for computing and cooling, operational and embedded carbon emissions and heat load. The embedded exergy consumption, which accounts for the loss in exergy (usable energy) for all components and manufacturing processes associated with each piece of equipment, from raw materials extraction to finished product may also be analyzed at step 210. Thus, for instance, the total embedded exergy consumption for the candidate design may be calculated from the individual exergy consumption values of the computer, cooling, and power equipment contained in the candidate design.

One or more of the operating characteristics, such as power consumption, may be calculated or measured. Knowledge about the operating policies, such as real-time management of computing loads to minimize power consumption may be incorporated into these calculations. However, the operating characteristic analysis module 112 may infer other operating characteristics, such as availability, from aggregated equipment reliability attributes and known industry best practices.

According to an example, the acquisition costs and operating costs associated with the computer equipment, the power equipment, and the cooling equipment contained in the candidate design are calculated. The water consumption of the identified cooling equipment may also be computed. In addition, the thermal performance of the IT infrastructure based on desired operational parameters, such as, IT infrastructure ambient temperature and the desired difference between rack inlet and outlet temperatures, may also be determined. The thermal performance of the IT infrastructure may be determined through implementation of a complete thermal analysis of the IT infrastructure operation using existing computational fluid dynamics analysis tools.

At step 212, a determination as to whether the one or more operating characteristics are acceptable is made by determining whether the one or more operating characteristics meet customer requirements for service delivery, for instance, by the design analyzing module 114. In response to the one or more operating characteristics being acceptable, the candidate design is identified as a potential solution, as indicated at step 214. Thus, for instance, the candidate design as well as the operating characteristics associated with the candidate design may be stored in the data store 120.

According to an embodiment, the candidate design may be identified as being acceptable even in situations where the one or more operating characteristics fail to meet all of the customer requirements, for instance, if the candidate design meets the service delivery requirements but fails to meet, for instance, TCO or other requirements. As such, the design analyzing module 114 may allow for trade-offs that may prove to be acceptable to the user. For example, a user may be able to make a significant improvement in sustainability for a small increase in TCO and may be willing to make that trade-off once these results are known.

In instances where one or more of the operating characteristics are deemed to be unacceptable at step 212, the candidate design may be identified as being unacceptable, as indicated at step 216. In other words, for instance, an indication that the candidate design generated at step 208 is unacceptable may constrain the solution such that the candidate design is not considered again during future iterations of the method 200.

Following either of steps 214 and 216, the design analyzing module 114 may instruct the IT equipment synthesizing module 106 and the auxiliary infrastructure synthesizing module 108 to identify one or more of the IT equipment and auxiliary infrastructure to change for another iteration of steps 204-212. The design analyzing module 114 may provide suggestions on which of the one or more of the IT equipment and auxiliary infrastructure to change based upon the analysis performed at step 210, while still meeting the computing, power, and cooling requirements discussed above. Thus, for instance, if the operating characteristic is energy consumption, the design analyzing module 114 may instruct the IT equipment synthesizing module 106 and/or the auxiliary infrastructure synthesizing module 108 to select one or more equipment that consumes less energy.

In addition, at step 220, the IT equipment synthesizing module 106 and/or the auxiliary infrastructure synthesizing module 108 selects the identified change in equipment and forwards that information to the candidate design generating module 110. The IT equipment and the auxiliary infrastructure may be selected at step 220 in any of the manners discussed above with respect to steps 204 and 206. In addition, another candidate design may be generated using the new IT equipment and auxiliary infrastructure at step 208. Moreover, steps 210-220 are repeated on the another candidate design.

According to an embodiment, the synthesizer 102 repeats steps 208-220 until further solutions are not possible within the given constraints, after an established maximum has been reached for the number of solutions to be considered, after a predetermined number of iterations, etc. Thus, for instance, the design analyzing module 114 may identify a number of candidate designs that are potential solutions for the IT infrastructure at step 214. In this embodiment, at step 222, the design analyzing module 114 selects one of the candidate designs identified as being a potential solution at step 214 as an optimized IT infrastructure design. In addition, at step 224, the output module 116 outputs the selected solution to the data store 120 and/or to the output 140 as discussed above.

Alternatively to step 222, multiple ones of the candidate designs that have been identified as being potential solutions may be visually outputted to a user and the user may select one of the candidate designs. In this regard, the user may be presented with multiple options and may consider various factors in selecting a IT infrastructure design.

According to another embodiment, steps 208-220 may be performed as part of an optimization loop, such as a genetic algorithm, simulated annealing algorithm, or the like, in which tentative solutions are attempted and changes are made to design space. In this embodiment, those points in the design space that are likely to yield acceptable operating characteristics may be stored in the data store 120 at step 214. In addition, an optimized solution or multiple candidate solutions may be presented to the user at step 224.

Some or all of the operations set forth in the methods 200 and 300 may be contained as utilities, programs, or subprograms, in any desired computer accessible medium. In addition, the methods 200 and 300 may be embodied by computer programs, which can exist in a variety of forms both active and inactive. For example, they may exist as software program(s) comprised of program instructions in source code, object code, executable code or other formats. Any of the above may be embodied on a computer readable storage medium.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

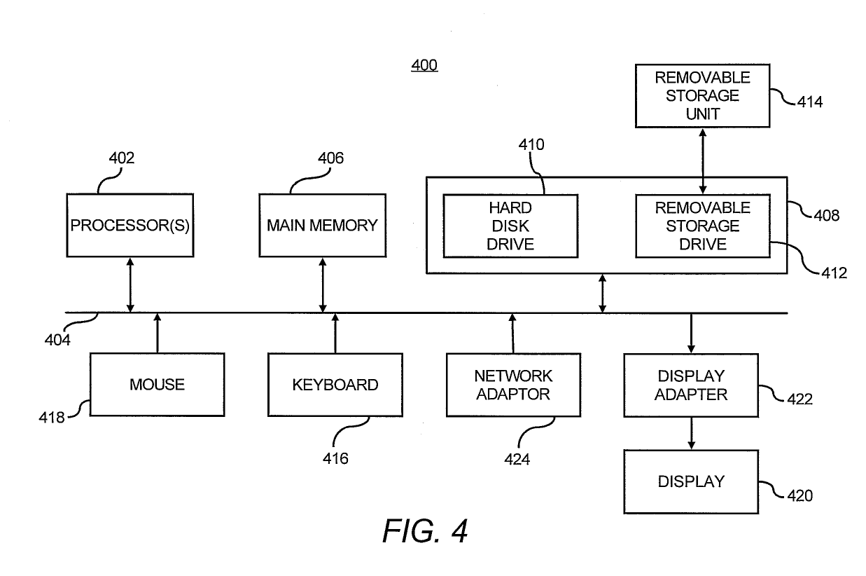

FIG. 4 illustrates a block diagram of a computing apparatus 400 configured to implement or execute the methods 200 and 300 depicted in FIGS. 2 and 3, according to an example. In this respect, the computing apparatus 400 may be used as a platform for executing one or more of the functions described hereinabove with respect to the synthesizer 102.

The computing apparatus 400 includes a processor 402 that may implement or execute some or all of the steps described in the methods 200 and 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods 200 and 300 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims and their equivalents in which all terms are mean in their broadest reasonable sense unless otherwise indicated.

What is claimed is:

1. A method for automated design of an information technology (IT) infrastructure, said method comprising steps performed by a processor of:
a) identifying IT equipment to support services to be provided to meet one or more user requirements;
b) identifying one or more auxiliary infrastructures to meet requirements of the identified IT equipment;
c) synthesizing the IT equipment and the auxiliary infrastructures to generate a candidate design;
d) analyzing one or more operating characteristics of the candidate design;
e) repeating steps a)-d) on at least one additional candidate design that differs from the candidate design generated at step c); and
f) storing at least one of the candidate design and the at least one additional candidate design.

2. The method according to claim 1, further comprising:
selecting one of the candidate designs for the design of the computing infrastructure based upon the analysis of one or more operating characteristics of the candidate design; and
outputting data pertaining to the selected design of the IT infrastructure.

3. The method according to claim 1, further comprising:
identifying IT equipment requirements to support the services from the one or more user requirements, and wherein step a) further comprises translating the identified IT equipment requirements to the IT equipment.

4. The method according to claim 1, wherein step a) further comprises selecting base platforms containing sets of IT equipment, performing application benchmarking on the selected base platforms, performing equipment profiling on the sets of IT equipment, cross-platform modeling of the sets of IT equipment, storing a plurality of resource profiles associated with the sets of IT equipment in a profile repository, and selecting a set of IT equipment that meet one or more constraints from the plurality of resource profiles stored in the profile repository to identify the IT equipment at step a).

5. The method according to claim 1, further comprising:
identifying auxiliary infrastructure requirements to meet the requirements of the identified IT equipment, and wherein step b) further comprises translating the identified auxiliary infrastructure requirements to the one or more auxiliary infrastructures.

6. The method according to claim 1, further comprising:
repeating steps a)-d) on a plurality of additional candidate designs, each of said plurality of additional candidate designs differing from other candidate designs;
storing one or more operating characteristics of the plurality of additional candidate designs; and
outputting one or more of the additional candidate designs.

7. The method according to claim 6, further comprising:
determining which feature of the plurality of additional candidate designs to modify based upon the analysis of the one or more operating characteristics of the plurality of additional candidate designs prior to repeating steps a)-d).

8. The method according to claim 1, further comprising:
determining whether the one or more operating characteristics of the candidate design is acceptable; and
performing step e) in response to a determination that at least one of the one or more operating characteristics of the candidate design is unacceptable.

9. The method according to claim 1, wherein step c) further comprises synthesizing the IT equipment and the one or more auxiliary infrastructures to generate a physical layout of the candidate design and wherein step d) further comprises analyzing the one or more operating characteristics based upon the physical layout of the candidate design.

10. The method according to claim 1, wherein step d) further comprises
identifying at least one of acquisition costs, physical dimensions, power input, heat output, reliability, and sustainability of the IT equipment and the one or more auxiliary infrastructures of the candidate design.

11. The method according to claim 1, wherein step d) further comprises determining one or more of total cost of ownership, availability, thermal conditions, water usage, and exergy consumption associated with operating the candidate design.

12. A synthesizer for automatically designing an information technology (IT) infrastructure, said synthesizer comprising:
a module for synthesizing information technology (IT) equipment to support services to be provided to meet one or more user requirements;
a module for synthesizing one or more auxiliary infrastructures that meet requirements of the synthesized IT equipment;
a module for generating candidate designs from the synthesized IT equipment and the synthesized one or more auxiliary infrastructures, wherein each of the generated candidate designs differs from each other; and
a module for analyzing one or more operating characteristics of the generated candidate designs.

13. The synthesizer according to claim 12, further comprising:
an input module for receiving the one or more user requirements from a user in the form of one or more service level objectives.

14. The synthesizer according to claim 12, wherein the module for generating the candidate designs is further configured to generate physical layouts of the candidate designs and wherein the operating characteristic analyzing module is further configured to analyze the one or more operating characteristics based upon the physical layouts of the candidate designs.

15. The synthesizer according to claim 12, wherein the candidate design generating module is further configured to identify at least one of acquisition costs, physical dimensions, power inputs, heat outputs, reliabilities, and sustainabilities of the candidate designs.

16. The synthesizer according to claim 12, wherein the one or more operating characteristics include one or more of total cost of ownership, availability, thermal conditions, water usage, and exergy consumption associated with operating the candidate designs.

17. The synthesizer according to claim 12, wherein the module for analyzing is further configured to select one of the candidate designs based upon the analyzed one or more operating characteristics of the candidate designs.

18. The synthesizer according to claim 12, wherein the module for analyzing is further configured to identify at least one feature of a candidate design to be modified based upon the analysis of the one or more operating characteristics and to cause the at least one feature to be modified prior to another candidate design being generated.

19. The synthesizer according to claim 12, further comprising:
an output module configured to output the generated candidate designs and the analyzed one or more operating characteristics of the generated candidate designs.

20. A computer readable storage medium on which is embedded one or more computer programs, said one or more computer programs implementing a method for automated design of an information technology (IT) infrastructure, said one or more computer programs comprising a set of instructions for:
a) identifying IT equipment to support services to be provided to meet one or more user requirements;
b) identifying one or more auxiliary infrastructures to meet requirements of the identified IT equipment;
c) synthesizing the IT equipment and the one or more auxiliary infrastructures to generate a candidate design;
d) analyzing one or more operating characteristics of the candidate design;
e) repeating steps a)-d) on at least one additional candidate design that differs from the candidate design generated at step c); and
f) storing at least one of the candidate design and the at least one additional candidate design.
